(19) United States
(12) Patent Application Publication
(10) Pub. No.: US 2026/0052066 A1
(43) Pub. Date: Feb. 19, 2026

(54) CONTEXT AWARE SECURE APPLICATION PROGRAMMING INTERFACE FOR GLOBAL NAVIGATION SATELLITE SYSTEM

(71) Applicant: QUALCOMM Incorporated, San Diego, CA (US)

(72) Inventors: Chandrasekhar JAYARAM, Bangalore (IN); Mukesh KUMAR, Bangalore (IN); Santoshkumar ZALAKE, Bengaluru (IN); Srinivas GANGJI, Bangalore (IN)

(21) Appl. No.: 18/805,487

(22) Filed: Aug. 14, 2024

(51) Int. Cl. H04L 41/0823; H04L 41/147

(52) U.S. Cl. CPC H04L 41/0823; H04L 41/147

(57) ABSTRACT

Aspects presented herein may enable a UE to secure global navigation satellite system (GNSS) application programming interface (API) based on context information. In one aspect, a UE receives, from at least one API, a request or an injection for an operating mode of the UE. The UE identifies an environment of the UE for the request or the injection based on at least one of: a set of GNSS measurements, a set of WWAN measurements, or a set of sensor measurements. The UE identifies, based on the request or the injection, a current receiver state and a predicted receiver state of the UE based on at least one of: location information, a position trajectory, map data, or traffic information. The UE configures the operating mode of the UE based on the environment, the current receiver state, and the predicted receiver state.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from at least one application programming interface (API), a request or an injection for an operating mode of a user equipment (UE). The apparatus identifies an environment of a user equipment (UE) for the request or the injection based on at least one of: a set of global navigation satellite system (GNSS) measurements, a set of wireless wide area network (WWAN) measurements, or a set of sensor measurements. The apparatus identifies, based on the request or the injection, a current receiver state and a predicted receiver state of the UE based on at least one of: location information, a position trajectory, map data, or traffic information. The apparatus configures the operating mode of the UE based on the environment, the current receiver state, and the predicted receiver state.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example of a vehicle performing map over the air in accordance with various aspects of the present disclosure.

FIG. 7 is a diagram illustrating an example of a GNSS application programming interface (API) in accordance with various aspects of the present disclosure.

FIG. 8 is a diagram illustrating an example of a context aware secure API in accordance with various aspects of the present disclosure.

FIG. 9 is a diagram illustrating an example of a decision engine that may be used by the context aware secure API for determining whether to accept or reject a request/injection in accordance with various aspects of the present disclosure.

FIG. 10A is a diagram illustrating an example of a GNSS look-ahead state transition in accordance with various aspects of the present disclosure.

FIG. 10B is a diagram illustrating an example of using a GNSS look-ahead context to determine whether a UE is deterministic or non-deterministic based on a lattice structure in accordance with various aspects of the present disclosure.

FIG. 11 is a diagram illustrating an example of how the context aware secure API may handle a time/position injection based on GNSS look-ahead context in accordance with various aspects of the present disclosure.

FIG. 12 is a diagram illustrating an example of how the context aware secure API may handle a request to set an aggressive quality-of-service (QoS) based on GNSS look-ahead context in accordance with various aspects of the present disclosure.

FIG. 13 is a diagram illustrating an example of how the context aware secure API may handle a request to delete assistance based on GNSS look-ahead context in accordance with various aspects of the present disclosure.

FIG. 14 is a flowchart of a method of positioning.

FIG. 15 is a flowchart of a method of positioning.

FIG. 16 is a diagram illustrating an example of a hardware implementation for an example apparatus and/or network entity.

### DETAILED DESCRIPTION

Aspects presented herein may improve the overall performance of global navigation satellite system (GNSS) positioning by providing techniques/algorithms that are capable of securing GNSS application programming interface (API) based on context information (the techniques/algorithms may collectively be referred to as a “context based secure API” for purposes of the present disclosure). For example, one aspect of the present disclosure provides an approach towards securing API for automotive GNSS in a cellular vehicle-to-everything (C-V2X) environment based on the user/environment context. In another aspect, an enhanced/secure GNSS API is provided using (1) a GNSS context based on GNSS, wireless wide area network (WWAN), and/or sensor measurements, and (2) a look-ahead context based on map-aiding/predicted trajectory. Based on the GNSS and the look-ahead context information, a UE or a GNSS API may dynamically determine the robustness level to handle an API request/rejection. As such, aspects presented herein may enable a UE to efficiently detect denial-of-service events without specifying additional hardware component(s) and/or higher computational resources while also improving the performance of the GNSS positioning.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

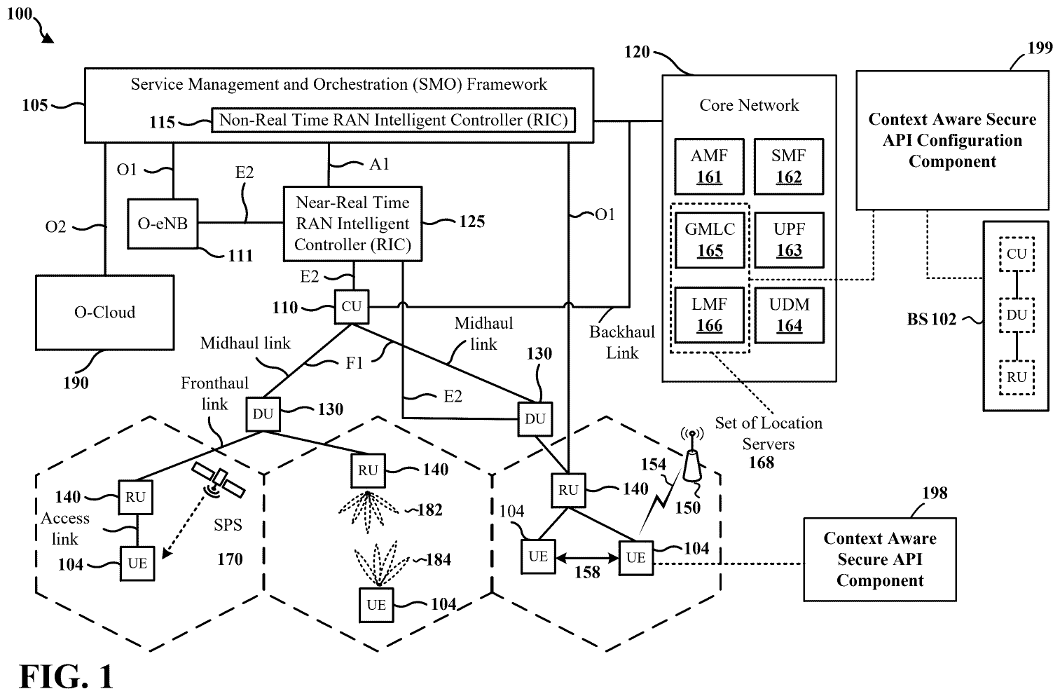

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-NB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a context aware secure API component 198 that may be configured to receive, from at least one application programming interface (API), a request or an injection for an operating mode of the UE; identify an environment of the UE for the request or the injection based on at least one of: a set of global navigation satellite system (GNSS) measurements, a set of wireless wide area network (WWAN) measurements, or a set of sensor measurements; identify, based on the request or the injection, a current receiver state and a predicted receiver state of the UE based on at least one of: location information, a position trajectory, map data, or traffic information; and configure the operating mode of the UE based on the environment, the current receiver state, and the predicted receiver state. In certain aspects, the base station 102 or the one or more location servers 168 may have a context aware secure API configuration component 199 that may be configured to provide configurations related to GNSS positioning and/or context aware secure API to the UE 104.

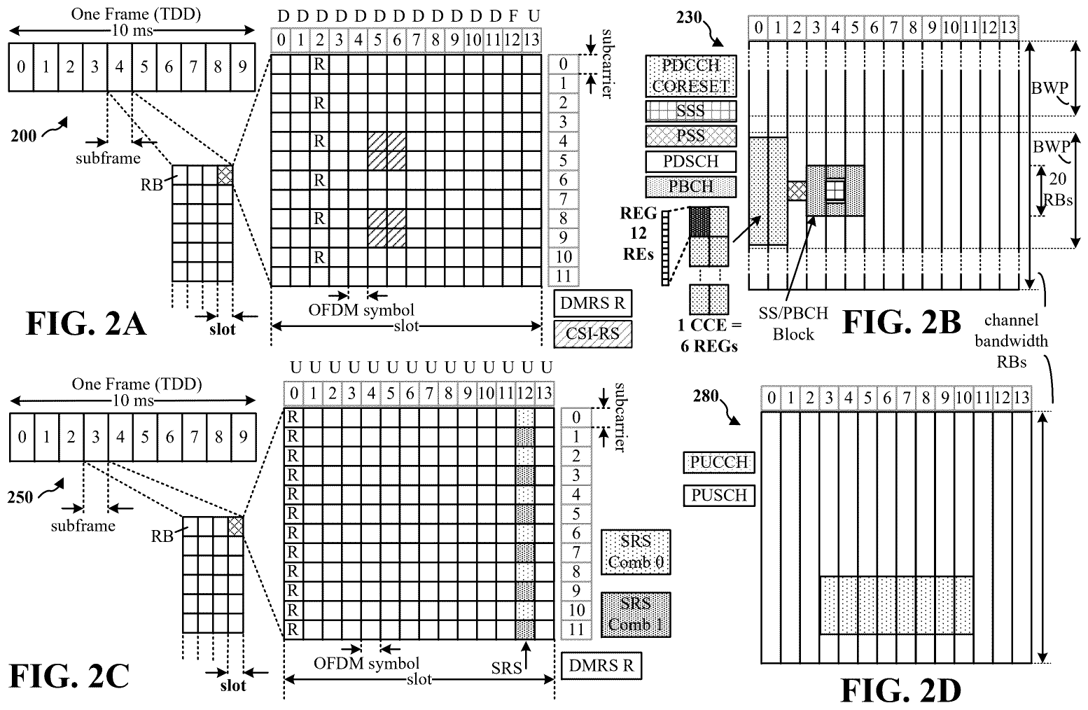

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

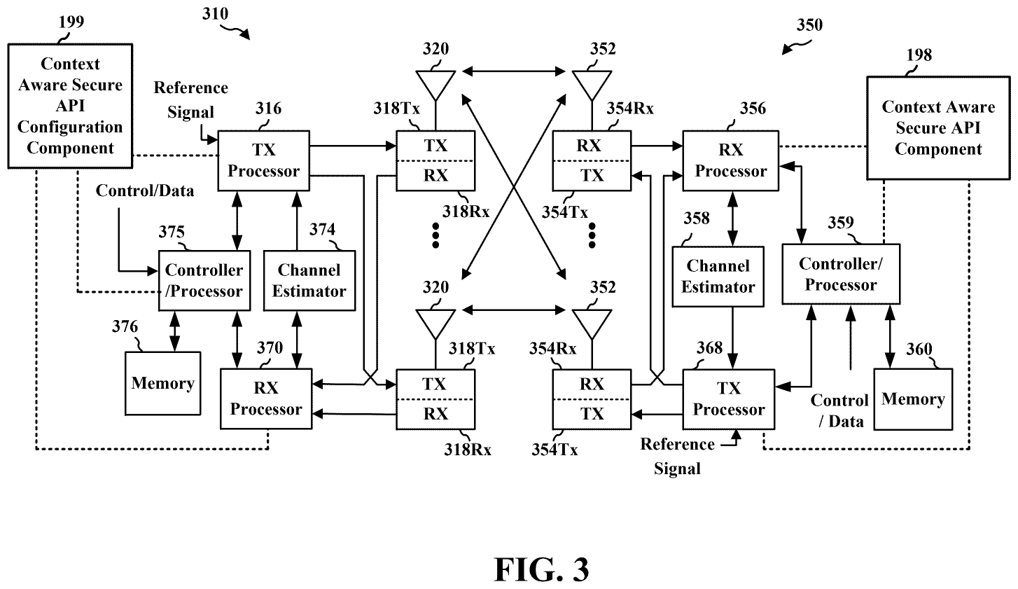

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the context aware secure API component 198 of FIG. 1.

At least one of the TX processor 316, the RX processor 370, and the controller/processor 375 may be configured to perform aspects in connection with the context aware secure API configuration component 199 of FIG. 1.

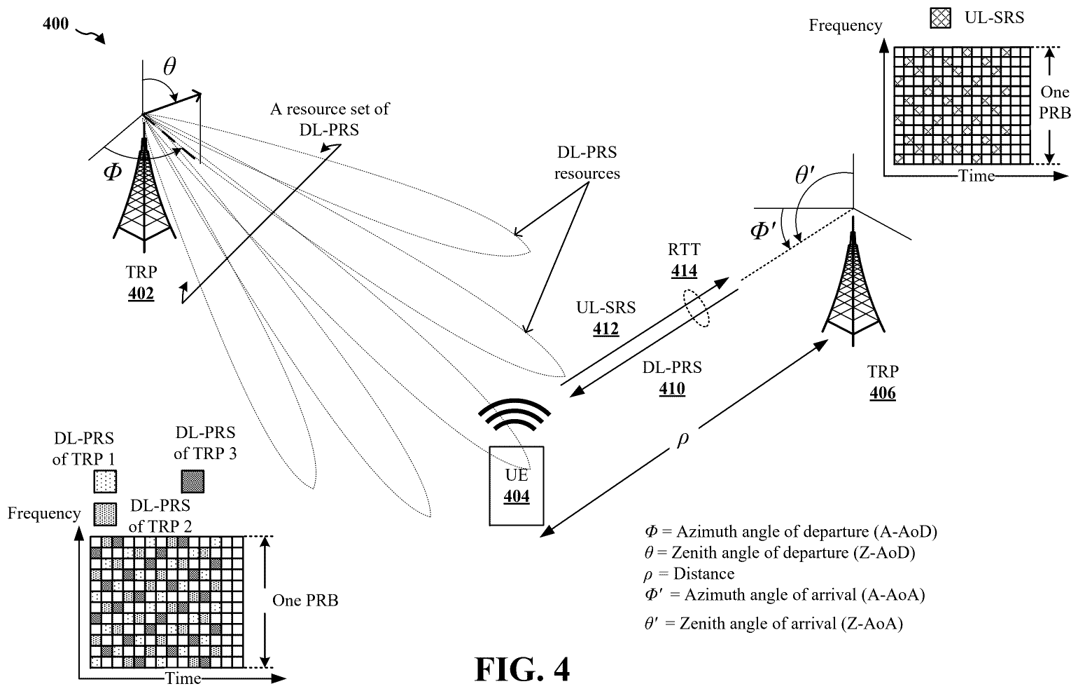

FIG. 4 is a diagram 400 illustrating an example of a UE positioning based on reference signal measurements (which may also be referred to as “network-based positioning”) in accordance with various aspects of the present disclosure. The UE 404 may transmit

UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}-T_{PRS_TX}|−|T_{SRS_TX}-T_{PRS_RX}∥. Accordingly, multi-RTT positioning may make use of the UE Rx-Tx time difference measurements (i.e., |T_{SRS_TX}-T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., ∥T_{SRS_RX}-T_{PRS_TX}∥) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FRI, the reference point for the DL PRS-RSRP may be the antenna connector of the UE. For FR2, DL PRS-RSRP may be measured based on the combined signal from antenna elements corresponding to a given receiver branch. For FRI and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE) equipped with a global navigation satellite system (GNSS) receiver may determine its location based on reception of signals from multiple satellites, which may be referred to as “GNSS positioning,” “GNSS-based positioning” or “satellite-based positioning,” etc. GNSS includes a network of satellites broadcasting timing and orbital information used for navigation and positioning measurements. In addition, GNSS may refer to the International Multi-Constellation Satellite System, which may include global positioning system (GPS), global navigation satellite system (GLONASS), BeiDou Navigation Satellite System (BDS), Galileo, and any other constellation system. GNSS may include multiple groups of satellites (which may be referred to as GNSS satellites), known as constellations, that broadcast signals (which may be referred to as GNSS signals) to control stations and users of the GNSS. Based on the broadcast signals, the users may be able to determine their locations (e.g., via a trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

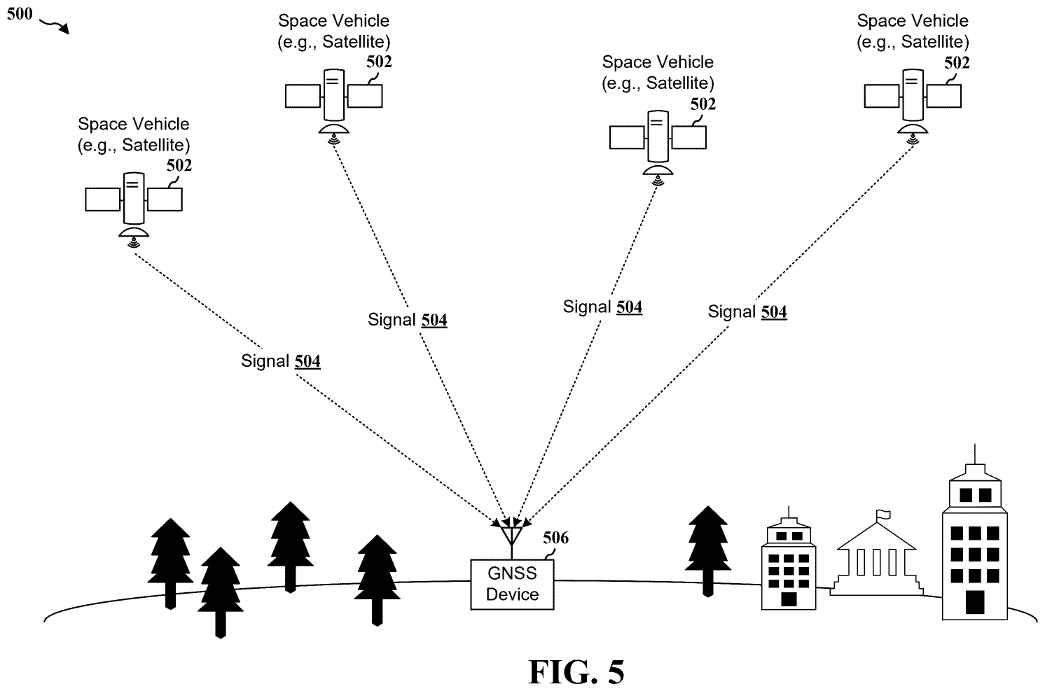

FIG. 5 is a diagram 500 illustrating an example of GNSS positioning in accordance with various aspects of the present disclosure. A GNSS device 506 may calculate its position and time based at least in part on data (e.g., GNSS signals 504) received from SVs 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (ToAs) of the GNSS signals 504 and calculate the time of flights (ToFs) for the GNSS signals 504. Then, based on the ToFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), radar(s), light detection and ranging (lidar(s) or lidar sensor(s)), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving, which may also be called as self-driving or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

To keep the map data up-to-date, applications or devices using the map data, such as the autonomous/assisted driving systems, may be configured to download updated map data from a server from time to time or based on certain pre-defined conditions (e.g., when travelling to an area that is without map data). In some implementations, downloading map data from a server may be referred to as “map over the air” (MOTA).

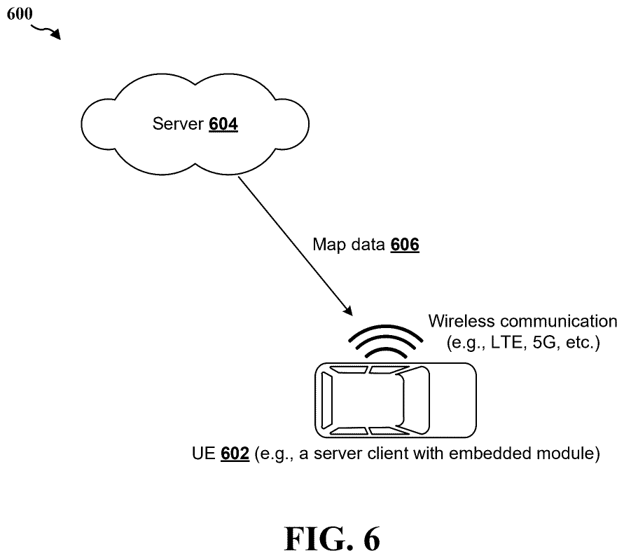

FIG. 6 is a diagram 600 illustrating an example of a vehicle performing map over the air in accordance with various aspects of the present disclosure. In one example, map over the air may refer to a process of a server 604 sending real-time map data 606 to a UE 602 (e.g., a vehicle, an assisted/autonomous driving system of the vehicle, an on-board unit (OBU) of the vehicle, an ADAS of the vehicle, a device running a navigation application, etc.) over a wireless network/communication (e.g., an LTE network, a 5G network, etc.), enabling the UE 602 to make decisions based on the latest information about the road and traffic conditions. In a typical implementation, the map data 606 is transmitted from the server 604 (e.g., a cloud-based system), where the server 604 may utilize sensors and other data sources to collect and analyze information about the road network and traffic patterns. This data is then processed and combined with other data, such as GPS/GNSS and/or camera data from multiple users (e.g., from other UEs/vehicles and/or the UE 602) to create a detailed map of the environment in real-time. Then, an application (e.g., for autonomous driving, navigation, positioning, etc.) of the UE 602 may access the map data 606 over a wireless network (e.g., a cellular or satellite network), and use the map data 606 to make decisions about speed, route, and other factors, etc. For example, the UE 602 may use the map data 606 to avoid road construction, traffic congestion, or accidents, and to optimize its route for efficiency and safety, etc.

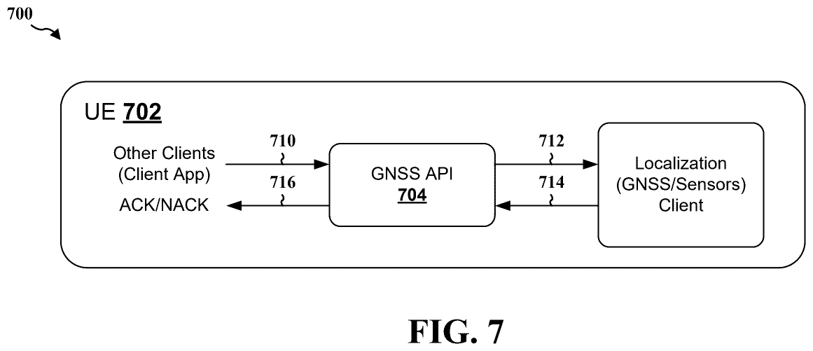

FIG. 7 is a diagram 700 illustrating an example of a GNSS application programming interface (API) in accordance with various aspects of the present disclosure. A GNSS API may refer to an interface (in a GNSS capable device such as a UE) that enables different applications to interact with and utilize or inject GNSS data and functionalities.

For example, at 710, a GNSS API 704 of a UE 702 may receive a request for GNSS related data/functionalities from a client application (App), such as a navigation application, a mapping application, an emergency service application, a location-based service application, or a social networking application, etc. Examples of GNSS related data/functionalities may include: (1) positioning data (e.g., the current location coordinates (e.g., latitude, longitude, and altitude) of the UE 702), (2) satellite information (e.g., information about the satellites currently in view, including their position, signal strength, and health status, etc.), (3) timing information (e.g., timing data derived from the GNSS satellites, which may be important for applications demanding precise time synchronization), (4) geofencing (e.g., capability to define virtual geographic boundaries and trigger actions when the UE 702 enters or exits these areas, (5) trajectory tracking (e.g., tracking the movement and recording the path of the UE 702 over time, and/or (6) accuracy and precision data (e.g., information about the accuracy and precision of the location data, which may be used to determine the reliability of the positioning information), etc.

At 712 and 714, based on the request from the client application, the GNSS API 704 may request and obtain the requested information from a set of corresponding localization clients, such as from a GNSS receiver and/or one or more sensors that may be used in association with the GNSS receiver/positioning (e.g., inertial measurement unit (IMU), camera, RF radar, Lidar, etc.). Then, at 716, the GNSS API 704 may provide the requested information to the client application.

In some examples, instead of or in addition to requesting GNSS related information, a client application may also be configured to inject information to a localization client via the GNSS API 704. For example, at 710 and 712, a client application may be configured to provide position/time information (e.g., which may be referred to as the “position/time injection”) and/or integrity/SV health information, etc. to a localization client via the GNSS API 704, such as to assist the localization client with estimating the position of the UE 702, acquiring the GNSS satellites, improving the performance of the localization client, verifying measurements of the localization client, etc. At 714 and 716, the localization client may inform the client application regarding whether the information/injection provided by the client application has been accepted/injected by the localization client, such as by transmitting an indication of an acknowledgement (ACK) or a negative acknowledgement (NACK). In some examples, if the information/injection provided by the client application is accepted/injected by the localization client, the operation mode of the localization client (e.g., the GNSS receiver) or the UE 702 may be modified based on the information/injection. For example, if time/position information from a client application is injected to the GNSS receiver of the UE 702, the GNSS receiver may change its operation based on the time/position information, such as estimating the position of the UE 702 based on the injected information instead of based on GNSS signals.

In some scenarios, the GNSS API 704 and/or a localization client may deny/reject a request/injection from a client application, which may be referred to as a denial-of-service event. For example, A denial of service event for GNSS may occur when an intentional or unintentional action disrupts the normal operation and/or the availability of GNSS signals, preventing a UE from obtaining accurate positioning, navigation, and/or timing information. Typically, the denial-of-service events in GNSS may focus on one or more of the following: signal jamming (e.g., deliberate transmission of radio frequency signals that interfere with GNSS signals, rendering them unusable), spoofing (e.g., transmission of counterfeit GNSS signals that deceive GNSS receivers into calculating incorrect positions or times), and/or meaconing (e.g., an attacker captures GNSS signals from legitimate satellites, delays them, and then rebroadcasts them), etc. In some scenarios, the GNSS API 704 and/or a localization client may accept a request/injection from a client application, which may lead to a denial-of-service event.

As shown by the diagram 700 of FIG. 7, in an integrated firmware environment, the flow of information/interface with the GNSS (e.g., a GNSS receiver of the UE 702, the localization client) may be accomplished using multiple APIs. However, some of the APIs may be vulnerable to denial-of-service events (e.g., position/time in a cellular vehicle-to-everything (C-V2X) environment). Due to the vulnerabilities in the API, when a denial-of-service event occurs, a GNSS receiver/localization client may erroneously delete assistance data in the middle of a GNSS positioning session (e.g., based on a false request), obtain an incorrect position/time injection (e.g., from a rogue base station (BS) or roadside unit (RSU)), obtain incorrect integrity/SV health information, and/or receive an aggressive quality of service (QoS) setting (e.g., received a false instruction to set a very high QoS), etc., which may impact the accuracy and performance of the GNSS receiver/localization client(s). Although several techniques have been proposed to improve the robustness of the GNSS receivers to prevent/reduce denial-of-service events, such as using an advanced signal processing, a micro-electro-mechanical system (MEMS) sensor assistance, a navigation message authentication, and/or a network based real-time interference (RTI) technique, etc., these techniques typically demand additional hardware component(s) and/or higher computational resources.

Aspects presented herein may improve the overall performance of GNSS positioning by providing techniques/algorithms that are capable of securing GNSS API based on context information (the techniques/algorithms may collectively be referred to as a “context based secure API” for purposes of the present disclosure). For example, one aspect of the present disclosure provides an approach towards securing API for automotive GNSS in a C-V2X environment based on the user/environment context. In another aspect, an enhanced/secure GNSS API is provided using (1) a GNSS context based on GNSS/WWAN/sensor measurements, and (2) a look-ahead context based on map-aiding/predicted trajectory. Based on the GNSS and the look-ahead context information, a UE or a GNSS API may dynamically determine the robustness level to handle an API request/rejection. As such, aspects presented herein may enable a UE to efficiently detect denial-of-service events without specifying additional hardware component(s) and/or higher computational resources while also improving the performance of the GNSS positioning.

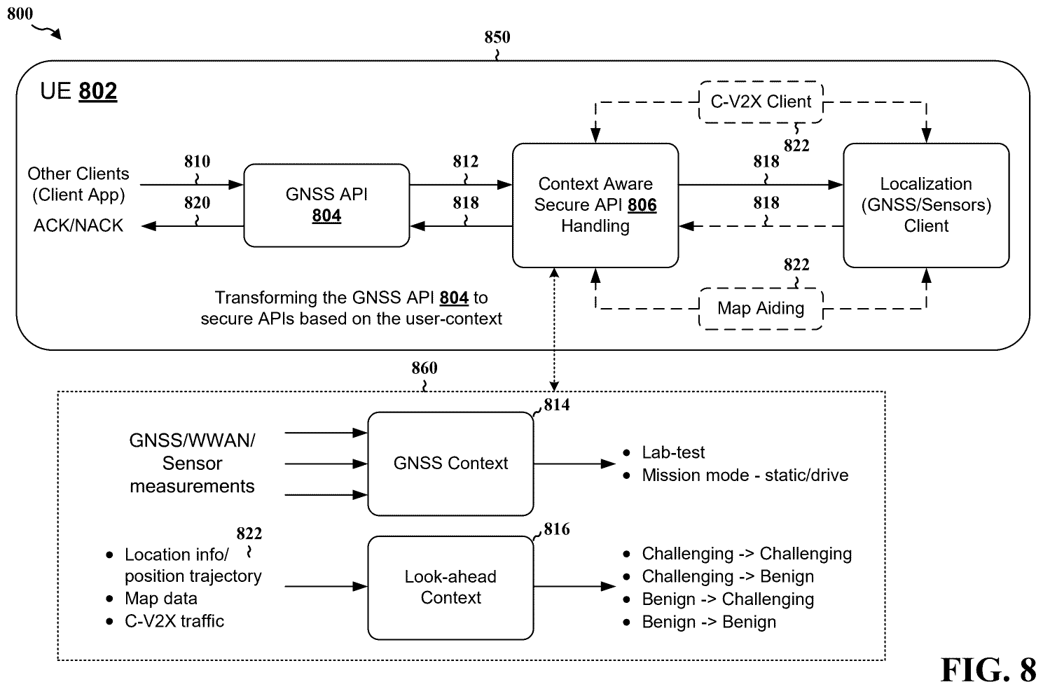

FIG. 8 is a diagram 800 illustrating an example of a context aware secure API in accordance with various aspects of the present disclosure. As shown at 810 and 812 within 850, a GNSS API 804 of a UE 802 may receive, from a client application, a request for GNSS related data/functionalities and/or a request to inject information to one or more localization clients (collectively as the “request/injection” hereafter), such as described in connection with 710 of FIG. 7. Then, at 812, the GNSS API 804 may provide/forward the request/injection to a context aware secure API 806. Note while the diagram 800 shows the GNSS API 804 and the context aware secure API 806 as two different/separate APIs/modules, it is merely for illustration purposes. Depending on implementations, the context aware secure API 806 may be configured to be part of the GNSS API 804, part of a localization client, or part of another API/module, etc. In that case, the context aware secure API 806 may obtain the request/injection from another API/module, such as directly from the client application.

One goal of the context aware secure API 806 is to transform the GNSS API 804 to secure APIs based on the user-context. In one aspect of the present disclosure, as shown at 860, the context aware secure API 806 may be configured to detect/identify different contexts based on various inputs. For example, as shown at 814, the context aware secure API 806 may identify an environment (which may be referred to as a “GNSS context” for simplicity of illustration) of the UE 802 for the request/injection based on: GNSS measurement(s), wireless wide area network (WWAN) measurement(s), and/or sensor measurement(s). In one example, the identified environment (or the identified GNSS context) may indicate whether the UE 802 is in a lab or test environment (collectively as a “simulated environment”), such that signals received by the UE 802 are likely to be imitated signals. The identification of the environment may be based on the location of the UE 802, the images captured by a camera of the UE, etc. In such cases, the context aware secure API 806 may be configured to allow request/injection to be accepted (by a localization client, by the GNSS API 804, and/or by the client application). In another example, the identified environment (or the identified GNSS context) may indicate whether the UE 802 is static or dynamic (e.g., moving/in a driving mode) (e.g., based on the location of the UE 802, the speed of the UE 802, etc.), such that signals received by the UE 802 should not be imitated signals. In such cases, the context aware secure API 806 may be configured to deny request/injection to be accepted (by a localization client, by the GNSS API 804, and/or by the client application), or to perform additional verification (or a cross-verification) for the signals/request/injection (discussed below). In some examples, the GNSS context detection may be configured to be data-driven/heuristic, where GNSS/WWAN/sensor measurement(s) may be configured to map to one of the defined states (e.g., lab/test environment, static, dynamic, etc.).

In another example, as shown at 816, the context aware secure API 806 may identify a current GNSS receiver state and a predicted GNSS receiver state of the UE 802 (which may be referred to as a “look-ahead context” for simplicity of illustration) for the request/injection based on the location information of the UE 802, the position trajectory of the UE 802, map data (e.g., HD map data), and/or (live/predicted) traffic information (e.g., from other UE(s) or a network via C-V2X), etc. Based on the look-ahead context (e.g., the current GNSS receiver state and the predicted GNSS receiver state of the UE 802), the context aware secure API 806 may determine whether the UE 802 is (currently) in an area with poor GNSS reception (e.g., the number of available GNSS satellites is below a number threshold, the signal strength of the GNSS satellites is below a signal threshold, etc.), or whether the UE 802 is in an area with good/acceptable GNSS reception (e.g., the number of available GNSS satellites is above the number threshold, the signal strength of the GNSS satellites is above the signal threshold, etc.). For simplicity of illustration, an area/state with poor GNSS reception may be referred to as a “challenging area/state,” whereas an area/state with good/acceptable GNSS reception may be referred to as a “benign area/state.” In addition, the context aware secure API 806 may also determine (predict) whether the UE 802 is going to remain in a challenging area/state or a benign area/state (for a finite duration in future, such as next X minutes), to change/transition from a challenging area/state to a benign area/state, or to change/transition from a benign area/state to a challenging area/state, etc. (discussed below). In some examples, as shown at 822, the look-ahead context may be based on map-aiding/predicted trajectory, where map data, the location information of the UE 802, the road/traffic information from other UEs/network (which may collectively be referred to as the “C-V2X traffic”) may be used as input(s) for obtaining the look-ahead context.

Based on the GNSS context discussed in connection with 814 and/or the look-ahead context discussed in connection with 816, the context aware secure API 806 may determine whether the UE 802 is in a deterministic state or a non-deterministic state, and determine whether to accept, reject, or cache the request/injection based on the determination (discussed below). For example, at 818 within 850, if the GNSS API 804 determines to accept the request/injection, the GNSS API 804 may request and obtain the requested information from a set of corresponding localization clients, or reject the information from the client application to the localization client(s). If the GNSS API 804 determines to reject the request/injection, the GNSS API 804 may inform the client application regarding the rejection. For example, at 820, the GNSS API 804 may transmit an ACK/NACK to the client application regarding whether the request/injection has been accepted or rejected, such as described in connection with 716 of FIG. 7. Accordingly, based on the context information, the UE 802 (or the context aware secure API 806) may have the capability to determine the robustness level to handle the API request/injection on-the-go. In addition, aspects presented herein may secure various interfaces and their content/payload against denial-of-service attacks.

Table 2 below provides a list of examples showing how the context aware secure API 806 may handle the request/injection from a client application based on GNSS context and look-ahead context.

TABLE 2
Examples of Handling the Request/Injection based
on GNSS Context and Look-Ahead Context

| | | | API (Request/ |
|---|---|---|---|
| | Look-ahead | | Injection) |
| | Context | API | Handling Status |
| | (Current → | (e.g., Request/ | (e.g., Operating |
| GNSS Context | Predicted) | Injection) | Mode of UE) |
| Lab/test | — | Any | Accept the input |
| | | | (e.g., accept the |
| | | | request/injection) |
| Real | — | Inject | Cross-validate |
| environment (or | | time/position | with existing |
| mission mode) - | | | time/information |
| Static | | | before accepting |
| | | | the time/position |
| | | | injection |
| Real | Benign → | Inject | Cross-validate the |
| environment - | Benign | time/position | information with |
| dynamic | | injection | sensor aided fix |
| | | | before accepting |
| | | | the position/time |
| | | | aiding |
| Real | Benign/ | Delete | Selectively accept |
| environment - | Challenging → | assistance | the assistance |
| dynamic | Challenging | information | information as the |
| | | | context is |
| | | | transitioning to |
| | | | challenging |
| | | | environment |
| Real | Benign/ | Aggressive QoS | Based on the fix |
| environment - | Challenging → | (e.g., setting | reliability/ |
| dynamic | Challenging | accuracy level | availability reject |
| | | to very high) | the request if the |
| | | | QoS threshold is |
| | | | below a defined |
| | | | value. |
| Real | Challenging → | Aggressive QoS | API may be |
| environment - | Benign | | effective at a |
| dynamic | | | specified time |
| | | | (e.g., T1) (when |
| | | | context changes |
| | | | to benign mode) |
| Real | Benign → | Integrity/health | Based on the fix |
| environment - | Benign | information | reliability after |
| dynamic | | | excluding the SVs |
| | | | in the integrity |
| | | | information, |
| | | | ACK/NACK is |
| | | | sent |

As illustrated by one example in Table 2, the GNSS context may indicate that the UE 802 is in a real environment (e.g., non-test/lab environment) and is moving, and the look-ahead context may indicate that the UE 802 is currently in a benign state and will continue to be in the benign state (for a defined/predicted period). Based on these contexts, if the UE 802 (or the context aware secure API 806) receives a time/position injection (e.g., from a client application), the UE 802 may be configured to handle the time/position injection based on cross-validating the time/position injection with a set of sensor aided fixes before accepting the time/position injection. In another example, the GNSS context may indicate that the UE 802 is in a real environment and is moving, and the look-ahead context may indicate that the UE 802 is currently in a benign state but is transition into a challenging state (for a defined/predicted period). Based on these contexts, if the UE 802 (or the context aware secure API 806) receives a request to delete assistance information (e.g., from a client application), the UE 802 may be configured to selectively accept the assistance information as the context is transitioning to challenging environment. In other words, based on the GNSS context and/or the look-ahead context, the UE 802 (or the context aware secure API 806) may determine how to handle a request/injection from an API (e.g., a client application). For purposes of the present disclosure, the handling of a request/injection by a UE (or by a GNSS/context aware secure API) may collectively be referred to as “an operating mode” or “changing an operating mode” of the UE.

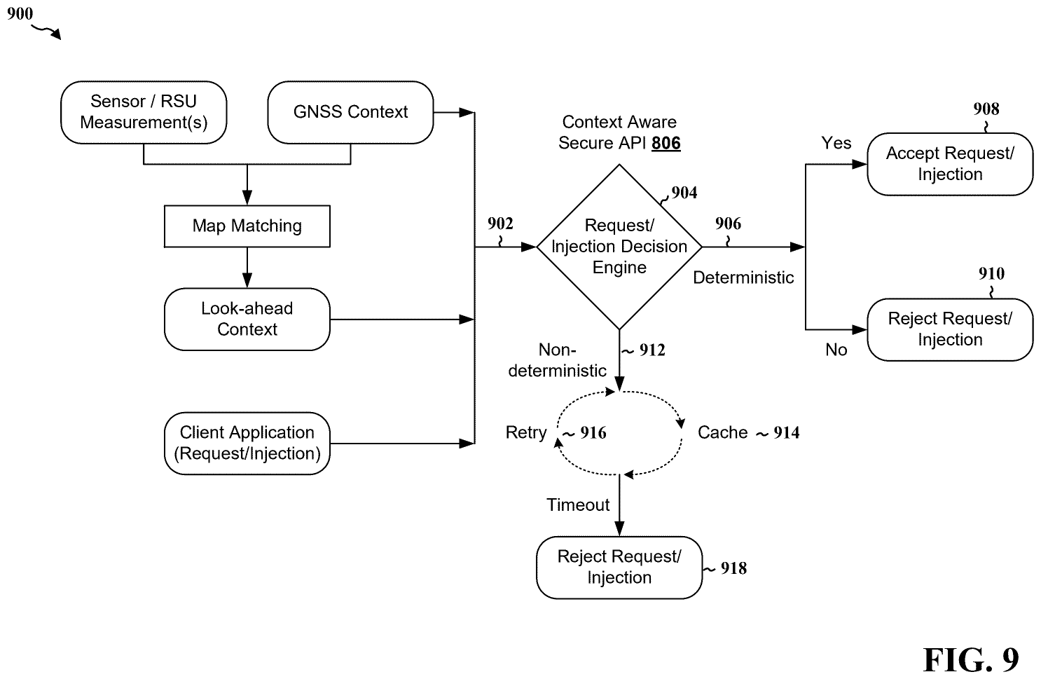

FIG. 9 is a diagram 900 illustrating an example of a decision engine that may be used by the context aware secure API for determining whether to accept or reject a request/injection in accordance with various aspects of the present disclosure. As shown at 902, a request/injection decision engine (of the context aware secure API 806) may be configured to receive the GNSS context, the look-ahead context, and the request/injection from a client application (which may be referred to as a “user API context”), such as described in connection with FIG. 8. For example, the GNSS context may be determined based on using GNSS/WWAN/sensor measurement(s), and the look-ahead context may be determined based on sensor measurement(s), information from a UE/network (e.g., C-V2X traffic), and map data.

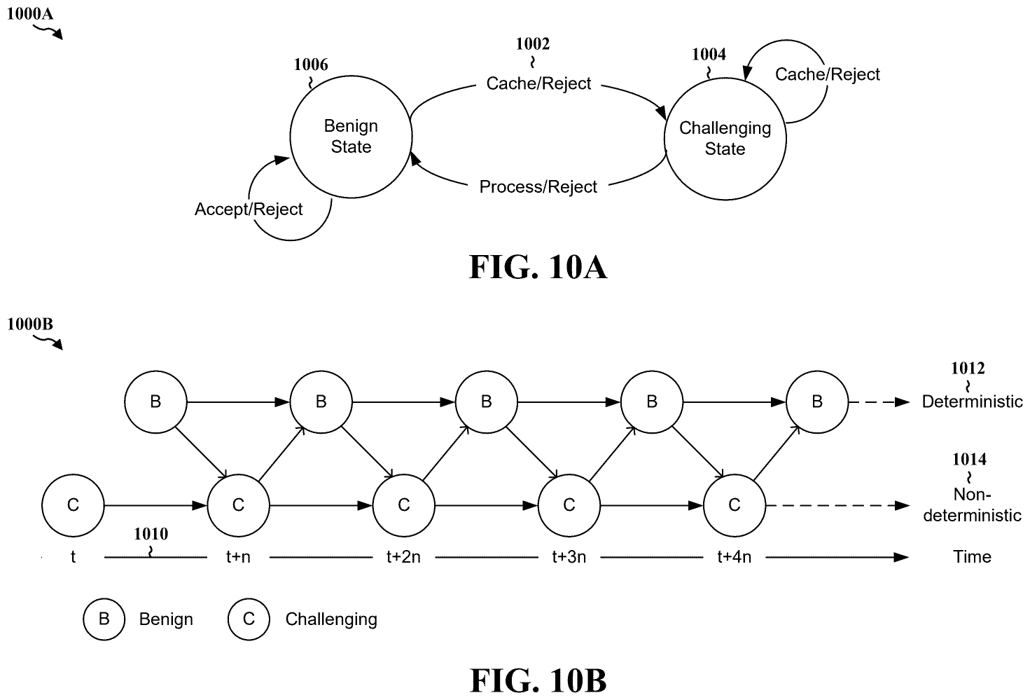

As shown at 904, after receiving the GNSS context, the look-ahead context, and/or the user API context, the request/injection decision engine (which may also be referred to as an API decision engine) may first identify whether the UE 802 (or the context aware secure API 806) is deterministic/in a deterministic state or is not deterministic/in a non-deterministic state. The determination of whether the UE 802 is deterministic/in a deterministic state or is not deterministic/in a non-deterministic state may be mainly based on the look-ahead context. For purposes of the present disclosure, being deterministic/in a deterministic state may refer to the UE 802 (or its GNSS receiver/positioning engine) being able to determine the position of the UE 802 (with an accuracy above an accuracy threshold), which typically occurs when the UE 802 is in a benign state for a period of time (under a real environment or under a simulated environment). In some examples, being deterministic/in a deterministic state may further specify the UE to be aware of the environment context. In other words, being deterministic/in a deterministic state may refer to the UE 802 (or its GNSS receiver/positioning engine) being able to determine the position of the UE 802 and aware of the environment context. Conversely, not being deterministic/in a non-deterministic state may refer to the UE 802 (or its GNSS receiver/positioning engine) not being able to determine the position of the UE 802 (with an accuracy above the accuracy threshold) and/or not being aware of the environment context (with certain confidence level), which typically occurs when the UE 802 is in a challenging state or is about to transition into a challenging state in a real environment (discussed below in connection with FIGS. 10A and 10B).

As shown at 906, if the request/injection decision engine determines that the UE 802 is deterministic/in a deterministic state (e.g., the UE 802 or its GNSS receiver/positioning engine is able to determine the position of the UE with certain accuracy), the request/injection decision engine may determine whether to accept or reject a request/injection. For example, if the request/injection contradicts or is inconsistent with the position of the UE 802, or is unable to be fulfilled by the UE 802, the request/injection decision engine may reject the request/injection as shown at 910. However, if the request/injection does not contradict or is consistent with the position of the UE 802 (and is able to be fulfilled by the UE 802), the request/injection decision engine may accept the request/injection as shown at 908.

On the other hand, as shown at 912, if the request/injection decision engine determines that the UE 802 is not deterministic/in a non-deterministic state (e.g., the UE 802 or its GNSS receiver/positioning engine is unable to determine the position of the UE with a specified accuracy or a QoS setting), the request/injection decision engine may be configured to cache the request/injection as shown at 914.

As shown at 916, when a request/injection is cached, the request/injection decision engine may initiate a timer and retry the request/injection (e.g., to check whether the UE 802 has become deterministic/transition into a deterministic state) at a defined periodicity (e.g., every X seconds) or at a defined set of intervals (e.g., retry the first time after five seconds, retry the second time after fifteen seconds, retry the third time after one minute, etc.). If the UE 802 is able to become deterministic/transition into a deterministic state before the timer runs out/expires, the request/injection decision engine may determine whether to accept or reject the request/injection such as described in connection with 906, 908, and 910. However, as shown at 918, if the UE 802 is unable to become deterministic/transition into a deterministic state before the timer runs out/expires, the request/injection decision engine may reject the request/injection.

FIG. 10A is a diagram 1000A illustrating an example of a GNSS look-ahead state transition in accordance with various aspects of the present disclosure. In another aspect of the present disclosure, the context aware secure API 806 (or the UE 802) may be configured to determine/obtain the GNSS context and/or the look-ahead context (collectively as “GNSS look-ahead context”) periodically based on the map-aiding (e.g., information from map data), C-V2X traffic (e.g., information from RSUs/UEs), and/or GNSS signals, etc., and then determine whether the UE 802 is deterministic/in a deterministic state or is not deterministic/in a non-deterministic state based on the GNSS look-ahead context.

In some implementations, as shown at 1002, the state transition (with a defined resolution of n seconds) may be configured to be determined/cached and updated by the context aware secure API 806 once in n seconds (n ≥1). The “state” may refer to the current state of the GNSS receiver, such as whether the GNSS receiver is in a benign state or in a challenging state as described in connection with 816 of FIG. 8. The “state transition” may refer to the transition of one state to another state (or determining whether a state is transition into another state), such as from a benign state to a challenging state, or from a challenging state to a benign state, etc. For example, the context aware secure API 806 may be configured to time-stamp the user API (e.g., the request/injection, the client application) at the first instance of the request/injection. Then, based on the state transition(s), the context aware secure API 806 may determine whether the UE 802 is deterministic/in a deterministic state or is not deterministic/in a non-deterministic state, and then cache (with a time-out), accept, or reject (either immediately or based on the time-out) the request/injection based on the determination. As describe in connection with FIG. 9, when a request/injection is cached, the context aware secure API 806 may again re-inject the request/injection without changing the time-stamp, and the cached request/injection may be gated through the GNSS look-ahead context.

For example, as shown at 1004, if the GNSS look-ahead context indicates that the UE 802 (or its GNSS receiver) is (currently) in a challenging state (and in a real environment), it may indicate that the UE 802 is not deterministic/in a non-deterministic state. As such, the context aware secure API 806 may be configured to cache or reject a request/injection. As shown at 1006, if the GNSS look-ahead context indicates that the UE 802 (or its GNSS receiver) is (currently) in a benign state (or is in a challenging state but under a simulated environment), it may indicate that the UE 802 is deterministic/in a deterministic state. As such, the context aware secure API 806 may be configured to accept or reject a request/injection.

In some examples, as shown at 1002, if the GNSS look-ahead context indicates that the UE 802 (or its GNSS receiver) is transition from a benign state to a challenging state (e.g., the current state of the UE 802 is the benign state and the predicted state of the UE 802 is the challenging state), the context aware secure API 806 may be configured to cache or reject a request/injection. However, if the GNSS look-ahead context indicates that the UE 802 (or its GNSS receiver) is transition from a challenging state to a benign state (e.g., the current state of the UE 802 is the challenging state and the predicted state of the UE 802 is the benign state), the context aware secure API 806 may be configured to process or reject a request/injection.

FIG. 10B is a diagram 1000B illustrating an example of using a GNSS look-ahead context to determine whether a UE is deterministic or non-deterministic based on a lattice structure in accordance with various aspects of the present disclosure. As shown at 1010, the context aware secure API 806 may be configured to estimate/predict the state of the GNSS receiver of the UE 802 periodically, such as every n seconds. As shown at 1012, if the GNSS receiver of the UE 802 is in a benign state or is transitioned from a challenging state to the benign state, the context aware secure API 806 may determine that the UE 802 is deterministic/in a deterministic state. As shown at 1014, if the GNSS receiver of the UE 802 is in a challenging state or is transitioned from a benign state to the challenging state, the context aware secure API 806 may determine that the UE 802 is not deterministic/in a non-deterministic state.

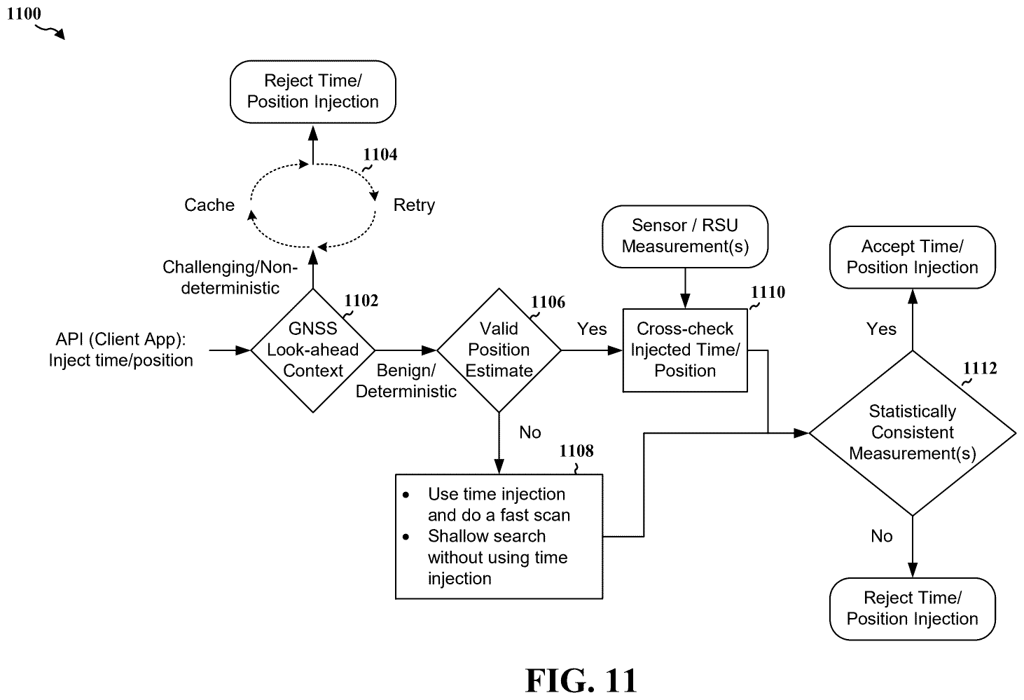

FIG. 11 is a diagram 1100 illustrating an example of how the context aware secure API may handle a time/position injection based on GNSS look-ahead context in accordance with various aspects of the present disclosure.

At 1102, the context aware secure API 806 (of the UE 802) may receive a time/position injection from a client application/API. Based on the GNSS context and the look-ahead context (collectively as “GNSS look-ahead context”), the context aware secure API 806 may determine whether the GNSS receiver of the UE 802 is in a challenging state (e.g., the UE 802 is not deterministic/in a non-deterministic state) or is in a benign state (e.g., the UE 802 is deterministic/in a deterministic state).

As shown at 1104, if the GNSS receiver of the UE 802 is determined to be in a challenging state, the context aware secure API 806 may be configured to cache the time/position injection, where the context aware secure API 806 may retry the time/position injection periodically, and reject the time/position injection if the GNSS receiver of the UE 802 is unable to transition into a benign state before a timer associated with the cached time/position injection runs out, such as described in connection with FIGS. 9, 10A, and 10B.

At 1106, if the GNSS receiver of the UE 802 is determined to be in a benign state or if the GNSS receiver of the UE 802 transitioned from a challenging state to a benign state while the time/position injection is cached (e.g., before the associated timer expires), the context aware secure API 806 may determine whether there is a valid position estimate (e.g., estimated by a positioning engine of the UE 802). As shown at 1108, if a valid position estimate is not available, the context aware secure API 806 (or the UE 802) may be configured to use the time injection to perform a fast scan, or perform a shallow search without using the time injection. During a GNSS signal detection process, a GNSS receiver may be configured with the resources to acquire the GNSS signals. Typically, based on the context, the GNSS receiver may demand a longer observation or averaging to detect the signals. The signal detection/acquisition may start with an assumption that the GNSS receiver is in benign environment. For this, a shallow search (e.g., a shorter observation) may be deployed to detect the GNSS signals. Typically, a shorter observation or averaging may imply a faster scanning of all the signal hypotheses where a GNSS receiver may find the GNSS signals. On the other hand, as shown at 1110, if a valid position estimate is available, the context aware secure API 806 (or the UE 802) may be configured to cross-check the time/position injection with the measurements from sensor(s) and/or C-V2X traffics (e.g., measurements from RSUs/sidelink UEs, etc.).

At 1112, based on the fast scan/shallow search performed at 1108 or based on the cross-check performed at 1110, the context aware secure API 806 (or the UE 802) may determine whether the time/position injection is statistically consistent with other measurements (e.g., the measurements from the cross-check/fast scan/shallow search). If the time/position injection is statistically consistent with other measurements, the context aware secure API 806 (or the UE 802) may accept the time/position injection. However, if the time/position injection is not statistically consistent with other measurements, the context aware secure API 806 (or the UE 802) may reject the time/position injection.

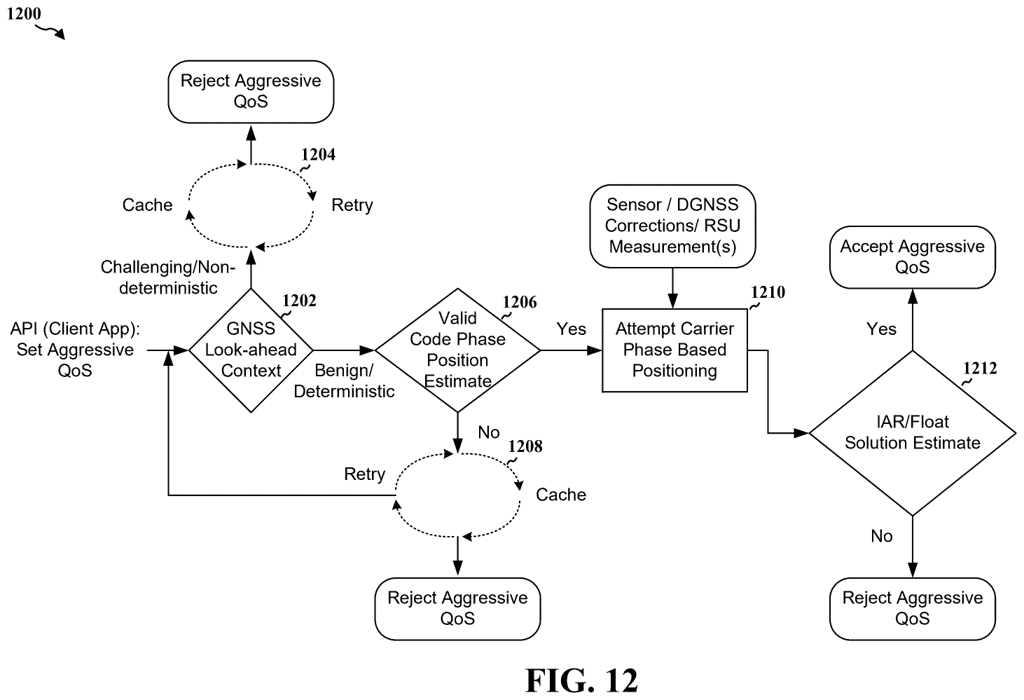

FIG. 12 is a diagram 1200 illustrating an example of how the context aware secure API may handle a request to set an aggressive QoS based on GNSS look-ahead context in accordance with various aspects of the present disclosure.

At 1202, the context aware secure API 806 (of the UE 802) may receive a request to set an aggressive QoS (hereafter simply “aggressive QoS”) from a client application/API. An aggressive QoS may refer to a setting that is considered very strict or demands very high standards. For example, an aggressive QoS may specify the positioning accuracy to be millimeter (mm)/decimeter (dm) accurate and/or a tighter/smaller session timeout value (e.g., in a challenging GNSS environment, a tighter/smaller session timeout may report error to the GNSS API, if a valid fix is not obtained within given timeout value), etc. Based on the GNSS context and the look-ahead context (collectively as “GNSS look-ahead context”), the context aware secure API 806 may determine whether the GNSS receiver of the UE 802 is in a challenging state (e.g., the UE 802 is not deterministic/in a non-deterministic state) or is in a benign state (e.g., the UE 802 is deterministic/in a deterministic state).

As shown at 1204, if the GNSS receiver of the UE 802 is determined to be in a challenging state, the context aware secure API 806 may be configured to cache the aggressive QoS, where the context aware secure API 806 may retry the aggressive QoS periodically, and reject the aggressive QoS if the GNSS receiver of the UE 802 is unable to transition into a benign state before a timer associated with the cached aggressive QoS runs out, such as described in connection with FIGS. 9, 10A, and 10B.

At 1206, if the GNSS receiver of the UE 802 is determined to be in a benign state or if the GNSS receiver of the UE 802 transitioned from a challenging state to a benign state while the aggressive QoS is cached (e.g., before the associated timer expires), the context aware secure API 806 may determine whether there is a valid code phase-based position estimate (e.g., estimated by a positioning engine of the UE 802). As shown at 1208, if a valid code phase-based position estimate is not available, the context aware secure API 806 (or the UE 802) may be configured to cache the aggressive QoS, where the context aware secure API 806 may continue to check whether there is a valid code phase-based position estimate (and that the GNSS receiver of the UE 802 is continue to be in the benign state) periodically, and reject the aggressive QoS if the GNSS receiver of the UE 802 is unable to obtain a valid code phase-based position estimate before a timer associated with the cached aggressive QoS (or associated with checking for a valid code phase-based position estimate) runs out.

On the other hand, as shown at 1210, if a valid code phase-based position estimate is available, the context aware secure API 806 (or the UE 802) may attempt to perform carrier phase-based positioning based on measurements from sensor(s), differential GNSS (DGNSS) corrections, and/or C-V2X traffics (e.g., measurements from RSUs/sidelink UEs, etc.).

At 1212, the context aware secure API 806 (or the UE 802) may be configured to estimate an integer ambiguity resolved (IAR) solution or a float solution based on the carrier phase positioning performed at 1210. In GNSS positioning, carrier measurements may be used for estimating the positioning with centimeter-level accuracy. For this, a GNSS receiver may be specified to resolve the integer ambiguities of carrier cycles. If the ambiguities are resolved, then there is an integer ambiguity resolved (IAR) fix. If the ambiguities are not resolved but treated as float values, then it may be termed as a float solution. If an IAR/float solution estimate is available, the context aware secure API 806 (or the UE 802) may accept the request to set an aggressive QoS. However, if an IAR/float solution estimate is not available, the context aware secure API 806 (or the UE 802) may reject the request to set an aggressive QoS.

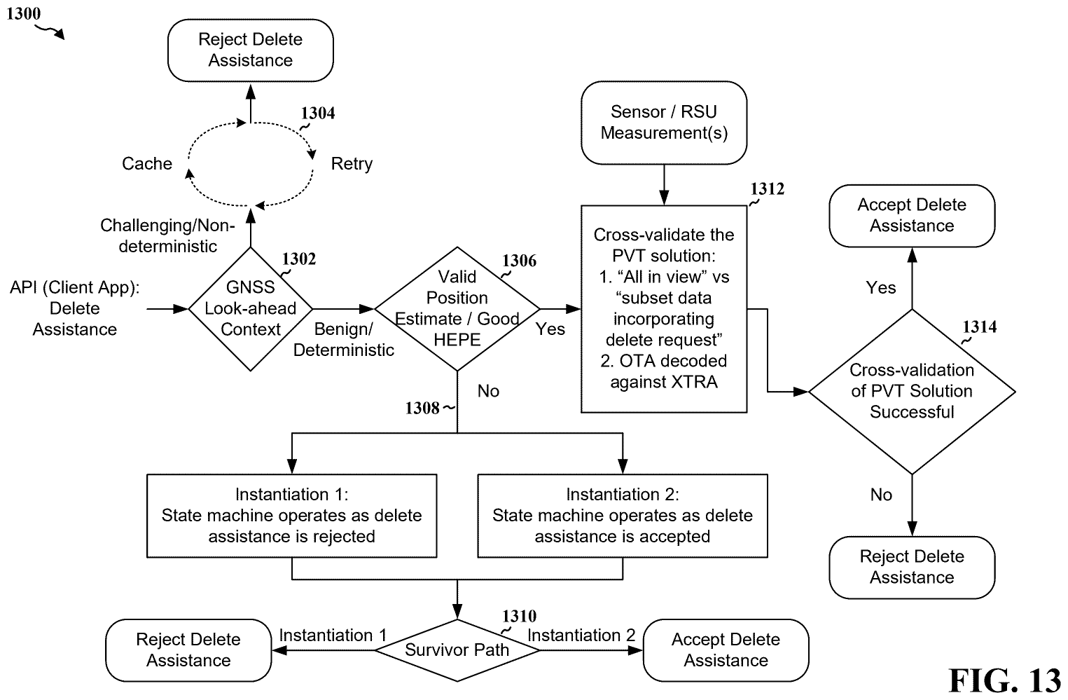

FIG. 13 is a diagram 1300 illustrating an example of how the context aware secure API may handle a request to delete assistance based on GNSS look-ahead context in accordance with various aspects of the present disclosure.

At 1302, the context aware secure API 806 (of the UE 802) may receive a request to delete assistance (hereafter simply “delete assistance”) from a client application/API. A request to delete assistance may refer to delete/reset certain assistance data associated with GNSS receiver/positioning (e.g., the satellite data, positioning information, almanac information, and/or integrity information, etc.) and/or delete cached map data. Based on the GNSS context and the look-ahead context (collectively as “GNSS look-ahead context”), the context aware secure API 806 may determine whether the GNSS receiver of the UE 802 is in a challenging state (e.g., the UE 802 is not deterministic/in a non-deterministic state) or is in a benign state (e.g., the UE 802 is deterministic/in a deterministic state).

As shown at 1304, if the GNSS receiver of the UE 802 is determined to be in a challenging state, the context aware secure API 806 may be configured to cache the delete assistance, where the context aware secure API 806 may retry the delete assistance periodically, and reject the delete assistance if the GNSS receiver of the UE 802 is unable to transition into a benign state before a timer associated with the cached delete assistance runs out, such as described in connection with FIGS. 9, 10A, and 10B.

At 1306, if the GNSS receiver of the UE 802 is determined to be in a benign state or if the GNSS receiver of the UE 802 transitioned from a challenging state to a benign state while the delete assistance is cached (e.g., before the associated timer expires), the context aware secure API 806 may determine whether there is a valid position estimate (e.g., estimated by a positioning engine of the UE 802) and/or whether there is a good horizontal estimated position error (HEPE) for the position estimate (e.g., the HEPE is below an error threshold).

As shown at 1308, if a valid position estimate (with a good HEPE) is not available, the context aware secure API 806 (or the UE 802) may be configured to either (1) continue to operate as the delete assistance is rejected (e.g., referring to as the “instantiation 1” in the diagram 1300), or (2) continue to operate as the delete assistance is accepted (e.g., referring to as the “instantiation 2” in the diagram 1300). As shown at 1310, based on the instantiation followed by the context aware secure API 806, the context aware secure API 806 may reject or accept the delete assistance. For example, if the context aware secure API 806 operates as the delete assistance is accepted, the context aware secure API 806 may accept the delete assistance.

On the other hand, as shown at 1312, if a valid position estimate (e.g., with a good HEPE) is available, the context aware secure API 806 (or the UE 802) may cross-validate it with a position, velocity, and time (PVT) solution, such as based on “all in view” vs “subset data incorporating delete request,” based on over-the-air (OTA) decoded against predicted satellite orbital states, etc., based on measurements from sensor(s) and/or C-V2X traffics (e.g., measurements from RSUs/sidelink UEs, etc.). For purposes of the present disclosure, all-in-view may refer to all the usable measurements. Subset data incorporating the delete request may refer to using just the measurements valid after incorporating the delete request. For ex: if all-in-view SVs are around 40 SVs, delete assistance request may be received for 10 SVs, then all-in-view based method uses 40 SVs subset data based method uses 30 SVs. As such, the two positions may be cross-validated to see if the delete request (e.g., using 30 SVs) has degraded QoS. This may be extended to the OTA decoded and predicated orbital state based methods as well.

At 1314, if the cross-validation of the PVT solution is successful, the context aware secure API 806 (or the UE 802) may accept the request to delete assistance. However, if the cross-validation of the PVT solution is not successful, the context aware secure API 806 (or the UE 802) may reject the request to delete assistance.

Aspects presented herein may improve the overall performance of GNSS positioning by providing techniques/algorithms that are capable of securing GNSS API based on context information. For example, aspects presented herein may secure API in automotive GNSS/C-V2X mode, improve the robustness in the presence of other denial-of-service (DoS) attacks (e.g., spoofing/jamming), provide robust GNSS in the presence of data exchanges across vehicles through V2X sidelink, avoid rogue RSU/V2X data (e.g., detection/exclusion), provide robustness against Web API vulnerabilities, and/or classify the APIs as safe/vulnerable and selectively apply context aware screening of vulnerable APIs.

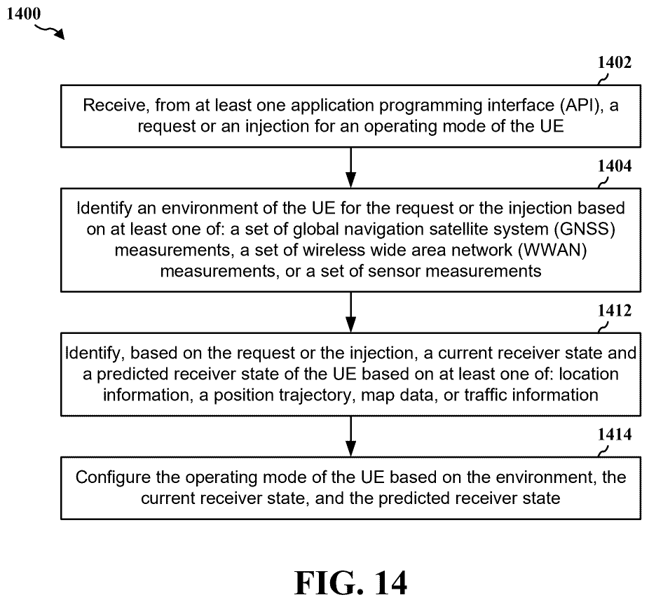

FIG. 14 is a flowchart 1400 of a method of at a user equipment (UE). The method may be performed by a UE (e.g., the UE 104, 404, 602, 702, 802; the GNSS device 506; the apparatus 1604). The method may enable the UE to secure GNSS API based on context information, thereby improving the overall performance of GNSS positioning.

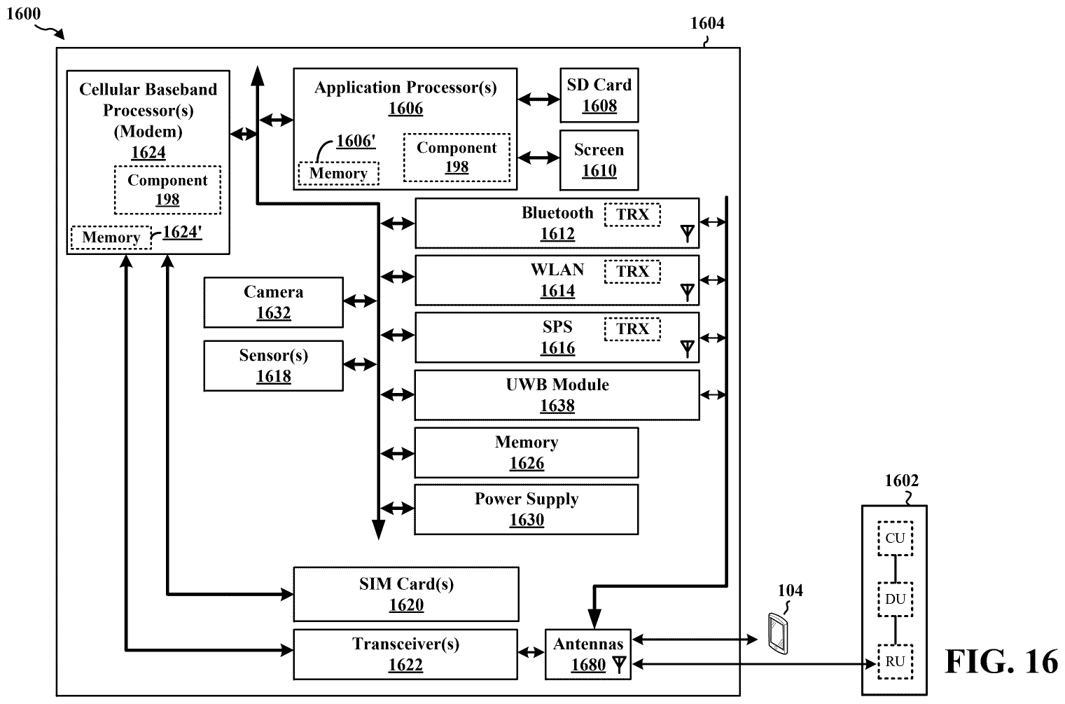

At 1402, the UE may receive, from at least one API, a request or an injection for an operating mode of the UE, such as described in connection with FIGS. 8 and 9. For example, at 810 of FIG. 8, a GNSS API 804 of a UE 802 may receive, from a client application, a request for GNSS related data/functionalities and/or a request to inject information to one or more localization clients (collectively as the “request/injection” hereafter). The reception of the request or the injection may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1404, the UE may identify an environment of the UE for the request or the injection based on at least one of: a set of GNSS measurements, a set of WWAN measurements, or a set of sensor measurements, such as described in connection with FIGS. 8 and 9. For example, at 814 of FIG. 8, the context aware secure API 806 may identify an environment (which may be referred to as a GNSS context for simplicity of illustration) of the UE 802 for the request/injection based on: GNSS measurement(s), WWAN measurement(s), and/or sensor measurement(s). The identification of the environment of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1412, the UE may identify, based on the request or the injection, a current receiver state and a predicted receiver state of the UE based on at least one of: location information, a position trajectory, map data, or traffic information, such as described in connection with FIGS. 8 and 9. For example, at 815 of FIG. 8, the context aware secure API 806 may identify a current GNSS receiver state and a predicted GNSS receiver state of the UE 802 (which may be referred to as a look-ahead context for simplicity of illustration) for the request/injection based on the location information of the UE 802, the position trajectory of the UE 802, map data (e.g., HD map data), and/or (live/predicted) traffic information (e.g., from other UE(s) or a network via C-V2X), etc. The identification of the current receiver state and the predicted receiver state of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1414, the UE may configure the operating mode of the UE based on the environment, the current receiver state, and the predicted receiver state, such as described in connection with FIGS. 8 and 9. For example, at 818 of FIG. 8, if the GNSS API 804 determines to accept the request/injection, the GNSS API 804 may request and obtain the requested information from a set of corresponding localization clients, or reject the information from the client application to the localization client(s). The configuration of the operating mode of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In one example, to configure the operating mode of the UE based on the environment, the current receiver state, and the predicted receiver state, the UE may be configured to determine whether the UE is in a deterministic state or a non-deterministic state based on the environment, the current receiver state, and the predicted receiver state, determine, based on whether the UE is in the deterministic state or the non-deterministic state, whether to accept, reject, or cache the request or the injection, and configure the operating mode of the UE based whether the request or the injection is accepted, rejected, or cached. In some implementations, the UE may further retry the request or the injection for a number of times if the request or the injection is cached, and reject the request or the injection if the request or the injection is not accepted or rejected after the number of times. In some implementations, to determine whether the UE is in the deterministic state or the non-deterministic state based on the environment, the current receiver state, and the predicted receiver state, the UE may be configured to determine the UE is in the deterministic state if the current receiver state and the predicted receiver state indicate that a signaling reception power of the UE is above a signaling power threshold or is within a first range of signaling power for a specified duration, or determine the UE is in the non-deterministic state if the current receiver state and the predicted receiver state indicate that the signaling reception power of the UE is below the signaling power threshold or is within a second range of signaling power for the specified duration.

In another example, to receive the request or the injection for the operating mode of the UE, the UE may be configured to receive the request or the injection for controlling the operating mode of at least one receiver or transceiver of the UE, and to configure the operating mode of the UE, the UE may be configured to configure the operating mode of the at least one receiver or transceiver of the UE.

In another example, the environment includes at least one of: a simulated environment, a static real environment, or a dynamic real environment. In some implementations, to configure the operating mode of the UE based on the environment, the current receiver state, and the predicted receiver state, the UE may be configured to accept the request or the injection for the operating mode of the UE based on the UE being in the simulated environment.

In another example, the UE may obtain at least one of the location information or the position trajectory based on the set of GNSS measurements, such as described in connection with FIG. 5. For example, a GNSS device 506 may calculate its position and time based at least in part on data (e.g., GNSS signals 504) received from SVs 502. The obtainment of at least one of the location information or the position trajectory may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, the UE may receive the map data from a server or at least one memory, such as described in connection with FIG. 6. For example, map over the air may refer to a process of a server 604 sending real-time map data 606 to a UE 602. The reception of the map data may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, the UE may obtain the traffic information from a C-V2X communication, such as described in connection with FIGS. 8 and 9. For example, at 816 of FIG. 8, 816, the context aware secure API 806 may identify a current GNSS receiver state and a predicted GNSS receiver state of the UE 802 based on . . . (live/predicted) traffic information (e.g., from other UE(s) or a network via C-V2X). The obtainment of the traffic information may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, the request for the operating mode of the UE includes at least one of: delete assistance information, set a QoS level, or obtain integrity or health information associated with the UE.

In another example, the injection for the operating mode of the UE includes at least one of: injecting a time for the UE, or injecting a position for the UE.

In another example, the UE may output an indication of the configuration of the operating mode of the UE. In some implementations, to output the indication of the configuration of the operating mode of the UE, the UE may be configured to transmit the indication of the configuration of the operating mode of the UE, or store the indication of the configuration of the operating mode of the UE.

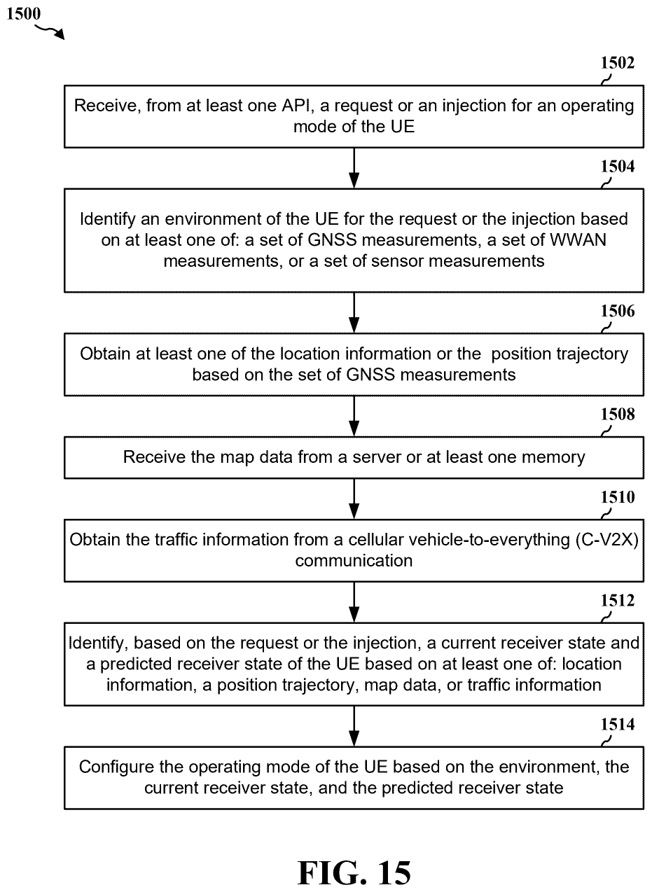

FIG. 15 is a flowchart 1500 of a method of at a user equipment (UE). The method may be performed by a UE (e.g., the UE 104, 404, 602, 702, 802; the GNSS device 506; the apparatus 1604). The method may enable the UE to secure GNSS API based on context information, thereby improving the overall performance of GNSS positioning.

At 1502, the UE may receive, from at least one API, a request or an injection for an operating mode of the UE, such as described in connection with FIGS. 8 and 9. For example, at 810 of FIG. 8, a GNSS API 804 of a UE 802 may receive, from a client application, a request for GNSS related data/functionalities and/or a request to inject information to one or more localization clients (collectively as the “request/injection” hereafter). The reception of the request or the injection may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1504, the UE may identify an environment of the UE for the request or the injection based on at least one of: a set of GNSS measurements, a set of WWAN measurements, or a set of sensor measurements, such as described in connection with FIGS. 8 and 9. For example, at 814 of FIG. 8, the context aware secure API 806 may identify an environment (which may be referred to as a GNSS context for simplicity of illustration) of the UE 802 for the request/injection based on: GNSS measurement(s), WWAN measurement(s), and/or sensor measurement(s). The identification of the environment of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1512, the UE may identify, based on the request or the injection, a current receiver state and a predicted receiver state of the UE based on at least one of: location information, a position trajectory, map data, or traffic information, such as described in connection with FIGS. 8 and 9. For example, at 815 of FIG. 8, the context aware secure API 806 may identify a current GNSS receiver state and a predicted GNSS receiver state of the UE 802 (which may be referred to as a look-ahead context for simplicity of illustration) for the request/injection based on the location information of the UE 802, the position trajectory of the UE 802, map data (e.g., HD map data), and/or (live/predicted) traffic information (e.g., from other UE(s) or a network via C-V2X), etc. The identification of the current receiver state and the predicted receiver state of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

At 1514, the UE may configure the operating mode of the UE based on the environment, the current receiver state, and the predicted receiver state, such as described in connection with FIGS. 8 and 9. For example, at 818 of FIG. 8, if the GNSS API 804 determines to accept the request/injection, the GNSS API 804 may request and obtain the requested information from a set of corresponding localization clients, or reject the information from the client application to the localization client(s). The configuration of the operating mode of the UE may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In one example, to configure the operating mode of the UE based on the environment, the current receiver state, and the predicted receiver state, the UE may be configured to determine whether the UE is in a deterministic state or a non-deterministic state based on the environment, the current receiver state, and the predicted receiver state, determine, based on whether the UE is in the deterministic state or the non-deterministic state, whether to accept, reject, or cache the request or the injection, and configure the operating mode of the UE based whether the request or the injection is accepted, rejected, or cached. In some implementations, the UE may further retry the request or the injection for a number of times if the request or the injection is cached, and reject the request or the injection if the request or the injection is not accepted or rejected after the number of times. In some implementations, to determine whether the UE is in the deterministic state or the non-deterministic state based on the environment, the current receiver state, and the predicted receiver state, the UE may be configured to determine the UE is in the deterministic state if the current receiver state and the predicted receiver state indicate that a signaling reception power of the UE is above a signaling power threshold or is within a first range of signaling power for a specified duration, or determine the UE is in the non-deterministic state if the current receiver state and the predicted receiver state indicate that the signaling reception power of the UE is below the signaling power threshold or is within a second range of signaling power for the specified duration.

In another example, to receive the request or the injection for the operating mode of the UE, the UE may be configured to receive the request or the injection for controlling the operating mode of at least one receiver or transceiver of the UE, and to configure the operating mode of the UE, the UE may be configured to configure the operating mode of the at least one receiver or transceiver of the UE.

In another example, the environment includes at least one of: a simulated environment, a static real environment, or a dynamic real environment. In some implementations, to configure the operating mode of the UE based on the environment, the current receiver state, and the predicted receiver state, the UE may be configured to accept the request or the injection for the operating mode of the UE based on the UE being in the simulated environment.

In another example, as shown at 1506, the UE may obtain at least one of the location information or the position trajectory based on the set of GNSS measurements, such as described in connection with FIG. 5. For example, a GNSS device 506 may calculate its position and time based at least in part on data (e.g., GNSS signals 504) received from SVs 502. The obtainment of at least one of the location information or the position trajectory may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, as shown at 1508, the UE may receive the map data from a server or at least one memory, such as described in connection with FIG. 6. For example, map over the air may refer to a process of a server 604 sending real-time map data 606 to a UE 602. The reception of the map data may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, as shown at 1510, the UE may obtain the traffic information from a C-V2X communication, such as described in connection with FIGS. 8 and 9. For example, at 816 of FIG. 8, 816, the context aware secure API 806 may identify a current GNSS receiver state and a predicted GNSS receiver state of the UE 802 based on . . . (live/predicted) traffic information (e.g., from other UE(s) or a network via C-V2X). The obtainment of the traffic information may be performed by, e.g., the context aware secure API component 198, the SPS module 1616, the one or more sensors 1618, the transceiver(s) 1622, the cellular baseband processor(s) 1624, and/or the application processor(s) 1606 of the apparatus 1604 in FIG. 16.

In another example, the request for the operating mode of the UE includes at least one of: delete assistance information, set a QoS level, or obtain integrity or health information associated with the UE.

In another example, the injection for the operating mode of the UE includes at least one of: injecting a time for the UE, or injecting a position for the UE.

In another example, the UE may output an indication of the configuration of the operating mode of the UE. In some implementations, to output the indication of the configuration of the operating mode of the UE, the UE may be configured to transmit the indication of the configuration of the operating mode of the UE, or store the indication of the configuration of the operating mode of the UE.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an ultrawide band (UWB) module 1638, an SPS module 1616 (e.g., GNSS module), one or more sensors 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the UWB module 1638, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the context aware secure API component 198 may be configured to receive, from at least one API, a request or an injection for an operating mode of the UE. The context aware secure API component 198 may also be configured to identify an environment of the UE for the request or the injection based on at least one of: a set of GNSS measurements, a set of WWAN measurements, or a set of sensor measurements. The context aware secure API component 198 may also be configured to identify, based on the request or the injection, a current receiver state and a predicted receiver state of the UE based on at least one of: location information, a position trajectory, map data, or traffic information. The context aware secure API component 198 may also be configured to configure the operating mode of the UE based on the environment, the current receiver state, and the predicted receiver state. The context aware secure API component 198 may be within the cellular baseband processor(s) 1624, the application processor(s) 1606, or both the cellular baseband processor(s) 1624 and the application processor(s) 1606. The context aware secure API component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving, from at least one API, a request or an injection for an operating mode of the UE. The apparatus 1604 may further include means for identifying an environment of the UE for the request or the injection based on at least one of: a set of GNSS measurements, a set of WWAN measurements, or a set of sensor measurements. The apparatus 1604 may further include means for identifying, based on the request or the injection, a current receiver state and a predicted receiver state of the UE based on at least one of: location information, a position trajectory, map data, or traffic information. The apparatus 1604 may further include means for configuring the operating mode of the UE based on the environment, the current receiver state, and the predicted receiver state.

In one configuration, the means for configuring the operating mode of the UE based on the environment, the current receiver state, and the predicted receiver state may include configuring the apparatus 1604 to determine whether the UE is in a deterministic state or a non-deterministic state based on the environment, the current receiver state, and the predicted receiver state, determine, based on whether the UE is in the deterministic state or the non-deterministic state, whether to accept, reject, or cache the request or the injection, and configure the operating mode of the UE based whether the request or the injection is accepted, rejected, or cached. In some implementations, the apparatus 1604 may further include means for retrying the request or the injection for a number of times if the request or the injection is cached, and means for rejecting the request or the injection if the request or the injection is not accepted or rejected after the number of times. In some implementations, to determine whether the UE is in the deterministic state or the non-deterministic state based on the environment, the current receiver state, and the predicted receiver state, the apparatus 1604 may be configured to determine the UE is in the deterministic state if the current receiver state and the predicted receiver state indicate that a signaling reception power of the UE is above a signaling power threshold or is within a first range of signaling power for a specified duration, or determine the UE is in the non-deterministic state if the current receiver state and the predicted receiver state indicate that the signaling reception power of the UE is below the signaling power threshold or is within a second range of signaling power for the specified duration.

In another configuration, the means for receiving the request or the injection for the operating mode of the UE may include configuring the apparatus 1604 to receive the request or the injection for controlling the operating mode of at least one receiver or transceiver of the UE, and the means for configuring the operating mode of the UE may include configuring the apparatus 1604 to configure the operating mode of the at least one receiver or transceiver of the UE.

In another configuration, the environment includes at least one of: a simulated environment, a static real environment, or a dynamic real environment. In some implementations, the means for configuring the operating mode of the UE based on the environment, the current receiver state, and the predicted receiver state may include configuring the apparatus 1604 to accept the request or the injection for the operating mode of the UE based on the UE being in the simulated environment.

In another configuration, the apparatus 1604 may further include means for obtaining at least one of the location information or the position trajectory based on the set of GNSS measurements.

In another configuration, the apparatus 1604 may further include means for receiving the map data from a server or at least one memory.

In another configuration, the apparatus 1604 may further include means for obtaining the traffic information from a C-V2X communication.

In another configuration, the request for the operating mode of the UE includes at least one of: delete assistance information, set a QoS level, or obtain integrity or health information associated with the UE.

In another configuration, the injection for the operating mode of the UE includes at least one of: injecting a time for the UE, or injecting a position for the UE.

In another configuration, the apparatus 1604 may further include means for outputting an indication of the configuration of the operating mode of the UE. In some implementations, the means for outputting the indication of the configuration of the operating mode of the UE may include configuring the apparatus 1604 to transmit the indication of the configuration of the operating mode of the UE, or store the indication of the configuration of the operating mode of the UE.

The means may be the context aware secure API component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of positioning at a user equipment (UE), comprising: receiving, from at least one application programming interface (API), a request or an injection for an operating mode of the UE; identifying an environment of the UE for the request or the injection based on at least one of: a set of global navigation satellite system (GNSS) measurements, a set of wireless wide area network (WWAN) measurements, or a set of sensor measurements; identifying, based on the request or the injection, a current receiver state and a predicted receiver state of the UE based on at least one of: location information, a position trajectory, map data, or traffic information; and configuring the operating mode of the UE based on the environment, the current receiver state, and the predicted receiver state.

Aspect 2 is the method of aspect 1, wherein configuring the operating mode of the UE based on the environment, the current receiver state, and the predicted receiver state comprises: determining whether the UE is in a deterministic state or a non-deterministic state based on the environment, the current receiver state, and the predicted receiver state; determining, based on whether the UE is in the deterministic state or the non-deterministic state, whether to accept, reject, or cache the request or the injection; and configuring the operating mode of the UE based whether the request or the injection is accepted, rejected, or cached.

Aspect 3 is the method of aspect 1 or aspect 2, further comprising: retrying the request or the injection for a number of times if the request or the injection is cached; and rejecting the request or the injection if the request or the injection is not accepted or rejected after the number of times.

Aspect 4 is the method of any of aspects 1 to 3, wherein determining whether the UE is in the deterministic state or the non-deterministic state based on the environment, the current receiver state, and the predicted receiver state comprises: determining the UE is in the deterministic state if the current receiver state and the predicted receiver state indicate that a signaling reception power of the UE is above a signaling power threshold or is within a first range of signaling power for a specified duration; or determining the UE is in the non-deterministic state if the current receiver state and the predicted receiver state indicate that the signaling reception power of the UE is below the signaling power threshold or is within a second range of signaling power for the specified duration.

Aspect 5 is the method of any of aspects 1 to 4, wherein receiving the request or the injection for the operating mode of the UE comprises receiving the request or the injection for controlling the operating mode of at least one receiver or at least one transceiver of the UE, and wherein configuring the operating mode of the UE comprises configuring the operating mode of the at least one receiver or the at least one transceiver of the UE.

Aspect 6 is the method of any of aspects 1 to 5, wherein the environment includes at least one of: a simulated environment, a static real environment, or a dynamic real environment.

Aspect 7 is the method of any of aspects 1 to 6, wherein configuring the operating mode of the UE based on the environment, the current receiver state, and the predicted receiver state comprises: accepting the request or the injection for the operating mode of the UE based on the UE being in the simulated environment.

Aspect 8 is the method of any of aspects 1 to 7, further comprising: obtaining at least one of the location information or the position trajectory based on the set of GNSS measurements.

Aspect 9 is the method of any of aspects 1 to 8, further comprising: receiving the map data from a server or at least one memory.

Aspect 10 is the method of any of aspects 1 to 9, further comprising: obtaining the traffic information from a cellular vehicle-to-everything (C-V2X) communication.

Aspect 11 is the method of any of aspects 1 to 10, wherein the request for the operating mode of the UE includes at least one of: deleting assistance information, setting a quality-of-service (QoS) level, or obtaining integrity or health information associated with the UE.

Aspect 12 is the method of any of aspects 1 to 11, wherein the injection for the operating mode of the UE includes at least one of: injecting a time for the UE, or injecting a position for the UE.

Aspect 13 is the method of any of aspects 1 to 12, further comprising: outputting an indication of the configuration of the operating mode of the UE.

Aspect 14 is the method of any of aspects 1 to 13, wherein outputting the indication of the configuration of the operating mode of the UE comprises: transmitting the indication of the configuration of the operating mode of the UE; or storing the indication of the configuration of the operating mode of the UE.

Aspect 15 is an apparatus for positioning at a user equipment (UE), including: at least one memory; and at least one processor coupled to the at least one memory and, based at least in part on information stored in the at least one memory, the at least one processor, individually or in any combination, is configured to implement any of aspects 1 to 14.

Aspect 16 is the apparatus of aspect 15, further including at least one transceiver coupled to the at least one processor.

Aspect 17 is an apparatus for positioning at a user equipment (UE), including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

What is claimed is:

1. An apparatus for positioning at a user equipment (UE), comprising:
at least one memory; and
at least one processor coupled to the at least one memory, the at least one processor, individually or in any combination, is configured to:
receive, from at least one application programming interface (API), a request or an injection for an operating mode of the UE;
identify an environment of the UE for the request or the injection based on at least one of: a set of global navigation satellite system (GNSS) measurements, a set of wireless wide area network (WWAN) measurements, or a set of sensor measurements;
identify, based on the request or the injection, a current receiver state and a predicted receiver state of the UE based on at least one of: location information, a position trajectory, map data, or traffic information; and
configure the operating mode of the UE based on the environment, the current receiver state, and the predicted receiver state.

2. The apparatus of claim 1, wherein to configure the operating mode of the UE based on the environment, the current receiver state, and the predicted receiver state, the at least one processor, individually or in any combination, is configured to:
determine whether the UE is in a deterministic state or a non-deterministic state based on the environment, the current receiver state, and the predicted receiver state;
determine, based on whether the UE is in the deterministic state or the non-deterministic state, whether to accept, reject, or cache the request or the injection; and
configure the operating mode of the UE based whether the request or the injection is accepted, rejected, or cached.

3. The apparatus of claim 2, wherein the at least one processor, individually or in any combination, is further configured to:
retry the request or the injection for a number of times if the request or the injection is cached; and
reject the request or the injection if the request or the injection is not accepted or rejected after the number of times.

4. The apparatus of claim 2, wherein to determine whether the UE is in the deterministic state or the non-deterministic state based on the environment, the current receiver state, and the predicted receiver state, the at least one processor, individually or in any combination, is configured to:
determine the UE is in the deterministic state if the current receiver state and the predicted receiver state indicate that a signaling reception power of the UE is above a signaling power threshold or is within a first range of signaling power for a specified duration; or
determine the UE is in the non-deterministic state if the current receiver state and the predicted receiver state indicate that the signaling reception power of the UE is below the signaling power threshold or is within a second range of signaling power for the specified duration.

5. The apparatus of claim 1, wherein to receive the request or the injection for the operating mode of the UE, the at least one processor, individually or in any combination, is configured to receive the request or the injection for controlling the operating mode of at least one receiver or at least one transceiver of the UE, and wherein to configure the operating mode of the UE, the at least one processor, individually or in any combination, is configured to configure the operating mode of the at least one receiver or the at least one transceiver of the UE.

6. The apparatus of claim 1, wherein the environment includes at least one of:
a simulated environment,
a static real environment, or
a dynamic real environment.

7. The apparatus of claim 6, wherein to configure the operating mode of the UE based on the environment, the current receiver state, and the predicted receiver state, the at least one processor, individually or in any combination, is configured to:
accept the request or the injection for the operating mode of the UE based on the UE being in the simulated environment.

8. The apparatus of claim 1, wherein the at least one processor, individually or in any combination, is further configured to:
obtain at least one of the location information or the position trajectory based on the set of GNSS measurements.

9. The apparatus of claim 1, wherein the at least one processor, individually or in any combination, is further configured to:
receive the map data from a server or the at least one memory.

10. The apparatus of claim 1, wherein the at least one processor, individually or in any combination, is further configured to:
obtain the traffic information from a cellular vehicle-to-everything (C-V2X) communication.

11. The apparatus of claim 1, wherein the request for the operating mode of the UE includes at least one of:
delete assistance information,
set a quality-of-service (QoS) level, or
obtain integrity or health information associated with the UE.

12. The apparatus of claim 1, wherein the injection for the operating mode of the UE includes at least one of:
injecting a time for the UE, or
injecting a position for the UE.

13. The apparatus of claim 1, wherein the at least one processor, individually or in any combination, is further configured to:
output an indication of the configuration of the operating mode of the UE.

14. The apparatus of claim 13, wherein to output the indication of the configuration of the operating mode of the UE, the at least one processor, individually or in any combination, is configured to:
transmit the indication of the configuration of the operating mode of the UE; or
store the indication of the configuration of the operating mode of the UE.

15. A method of positioning at a user equipment (UE), comprising:
receiving, from at least one application programming interface (API), a request or an injection for an operating mode of the UE;
identifying an environment of the UE for the request or the injection based on at least one of: a set of global navigation satellite system (GNSS) measurements, a set of wireless wide area network (WWAN) measurements, or a set of sensor measurements;
identifying, based on the request or the injection, a current receiver state and a predicted receiver state of the UE based on at least one of: location information, a position trajectory, map data, or traffic information; and
configuring the operating mode of the UE based on the environment, the current receiver state, and the predicted receiver state.

16. The method of claim 15, wherein configuring the operating mode of the UE based on the environment, the current receiver state, and the predicted receiver state comprises:
determining whether the UE is in a deterministic state or a non-deterministic state based on the environment, the current receiver state, and the predicted receiver state;
determining, based on whether the UE is in the deterministic state or the non-deterministic state, whether to accept, reject, or cache the request or the injection; and
configuring the operating mode of the UE based whether the request or the injection is accepted, rejected, or cached.

17. The method of claim 16, further comprising:
retrying the request or the injection for a number of times if the request or the injection is cached; and
rejecting the request or the injection if the request or the injection is not accepted or rejected after the number of times.

18. The method of claim 16, wherein determining whether the UE is in the deterministic state or the non-deterministic state based on the environment, the current receiver state, and the predicted receiver state comprises:
determining the UE is in the deterministic state if the current receiver state and the predicted receiver state indicate that a signaling reception power of the UE is above a signaling power threshold or is within a first range of signaling power for a specified duration; or
determining the UE is in the non-deterministic state if the current receiver state and the predicted receiver state indicate that the signaling reception power of the UE is below the signaling power threshold or is within a second range of signaling power for the specified duration.

19. The method of claim 15, wherein the request for the operating mode of the UE includes at least one of:
deleting assistance information,
setting a quality-of-service (QoS) level, or
obtaining integrity or health information associated with the UE.

20. A computer-readable medium storing computer executable code, the code when executed by at least one processor causes the at least one processor to:
receive, from at least one application programming interface (API), a request or an injection for an operating mode of a user equipment (UE);
identify an environment of the UE for the request or the injection based on at least one of: a set of global navigation satellite system (GNSS) measurements, a set of wireless wide area network (WWAN) measurements, or a set of sensor measurements;
identify, based on the request or the injection, a current receiver state and a predicted receiver state of the UE based on at least one of: location information, a position trajectory, map data, or traffic information; and
configure the operating mode of the UE based on the environment, the current receiver state, and the predicted receiver state.
